(19) United States
(12) Patent Application Publication
(10) Pub. No.: US 2012/0124474 A1
(43) Pub. Date: May 17, 2012

(54) USER PRESENTATION SETTINGS FOR MULTIPLE MEDIA USER INTERFACES

(75) Inventors: Gregory D. Suh, San Jose, CA (US); Ronald Quan, Cupertino, CA (US)

(73) Assignee: Rovi Technologies Corporation

(21) Appl. No.: 12/944,589

(22) Filed: Nov. 11, 2010

(51) Int. Cl. G06F 3/048

(52) U.S. Cl. 715/717

(57) ABSTRACT

Embodiments provide methods and apparatus for simultaneous presentation of multiple media user interfaces (UIs) based on user presentation settings. In some embodiments, a user may select presentation settings for a specific combination of at least two media UIs. The presentation settings may be stored and then retrieved and used when the specific combination of the at least two media UIs are later selected to be presented simultaneously. In some embodiments, presentation settings for a media UI comprise video and/or audio settings. Video settings may include position and size of a window presenting the media UI. Audio settings may include audio volume setting of the media UI. In some embodiments, each media UI in the combination of at least two media UIs may present a different type of media content (e.g., television content, Internet content, personal content, etc.).

### FIELD

The present invention relates to media systems, and, more specifically, to user presentation settings for multiple media user interfaces.

### BACKGROUND

The widespread use of computers, digital media devices, e.g., video, audio, image, picture, and/or gaming media devices, and the Internet has resulted in the generation and use of digital media files. Digital media files may contain binary data that provide various forms of media content (e.g., video, audio, image, or gaming content). Media files are typically stored on a computer storage medium that is accessible by computer devices, such as CD-ROMs, hard drives, memory sticks, etc.

The storage of digital media files on computer mediums allows for easy generation and transfer of digital media files. For example, it has become popular to purchase media files (e.g., video and audio files) on the Internet, and download and store the media files to computers. Also, it has become popular to generate digital photos by using a digital camera and then to transfer and store the digital photos to computers. Computer applications permit the user to manipulate and play back the media files. These types of applications have also contributed to the widespread popularity of digital media files.

The media files may then be played (decoded and presented) on a compatible playback device. A playback device may decode the digital media file to convert the digital data to analog signals (digital-to-analog conversion) and present the analog signals by using presentation components comprising video and/or audio components. For example, a video or gaming media file may be decoded and presented on a playback device having video and audio components (e.g., a display and speakers), an audio media file may be decoded and presented on a playback device having audio components (e.g., speakers or headphones), and an image media file may be decoded and presented on a playback device having a video component.

In addition to computer monitors, a television may be used as a video component (e.g., screen/display) for presenting video content and an audio component (e.g., speakers) for presenting audio content of a media file. Televisions may also present television content. Large, high definition televisions are currently popular for home use. With 1080 lines per picture and a screen aspect ratio (width to height ratio) of 16:9 (compared to 525 lines per picture and a 4:3 screen aspect ratio of standard definition television), high definition televisions provide more resolution than standard definition television (SDTV). With the larger displays available today, on televisions as well as computer monitors, modem displays may easily present multiple windows of media.

### SUMMARY

Embodiments described below provide methods and apparatus for simultaneous presentation of multiple media user interfaces (UIs) based on user presentation settings. In some embodiments, a user may select presentation settings for a specific combination of at least two media UIs. The presentation settings may be stored and then retrieved and used when the specific combination of the at least two media UIs are later selected to be presented simultaneously. In some embodiments, presentation settings for a media UI comprise video and/or audio settings. In some embodiments, each media UI in the combination of at least two media UIs may present a different type of media content.

In some embodiments, the presentation settings for specific combinations of media UIs are stored to a UI configuration (UIC) data structure comprising a plurality of entries. Each entry of the UIC data structure may specify a particular combination of at least two media UIs and presentation settings for each of the media UIs in the combination. The presentation settings for each media UI may be retrieved and used when the particular combination of media UIs are selected to be presented simultaneously.

In some embodiments, presentation settings for a media UI comprise video and/or audio settings. Video settings for a media UI may include the location/position and size of the window displaying the media UI. Audio settings for a media UI may include the audio volume setting for the media UI for presenting media content through the media UI. In some embodiments, each media UI in the combination of at least two media UIs may present a different type of media content. In some embodiments, types of media content include television, Internet, and personal content. Personal content may comprise video, audio, image, and/or gaming files stored on a local source device.

Embodiments may include a media system comprising at least one local source device, at least one multiple-media device (MMD), and presentation components. A local source device may store personal content comprising a plurality of media files of various types, e.g., video, audio, image, gaming media files, etc. The multiple-media device may present the media UIs and media content on the presentation components. The presentation components may include video components for presenting video content and audio components for presenting audio content. For example, the presentation components may be part of a television or a computer station.

In some embodiments, the multiple-media device executes a multiple-media application that provides at least two media UI applications for selecting media content for presentation on the presentation components. Each media UI may receive and present media content on the presentation components. For example, a television UI may be used to select and present television content (television channels) received from a television broadcast source. An Internet UI may be used to select and present Internet content received from an external Internet content provider. A personal UI may be used to select and present personal content comprising media files received from a source device.

In some embodiments, a user may select presentation settings for particular combinations of at least two media UIs to be presented simultaneously. The multiple-media device may comprise a local storage for storing a UIC data structure for storing and managing the presentation settings for the particular combinations of the media UIs. In these embodiments, a user may later select particular combinations of at least two media UIs to be presented simultaneously (in at least two different windows), whereby the presentation settings for the selected combination of media UIs are retrieved from the UIC data structure. In some embodiments, each media UI in a combination presents a different type of media content.

As such, the user may define and store desired presentation settings for particular combinations of media UIs. The presentation settings may then be automatically retrieved and used whenever the user selects the particular combination of media UIs or types of media content to be presented simultaneously, without having to re-establish the presentation settings of the media UIs each time the particular combination of media UIs are selected. This may be advantageous if the user typically prefers, for example, that the television UI be presented in a larger window and set to a higher audio volume than the Internet UI when presented together. Such user presentation settings may be stored and later retrieved and used automatically.

### BRIEF DESCRIPTION OF THE DRAWINGS

The novel features are set forth in the appended claims. However, for purpose of explanation, several embodiments of the invention are set forth in the following figures.

FIG. 1 is a block diagram of an exemplary media system environment in which some embodiments operate;

FIG. 2 is a diagram illustrating various components of a multiple-media device, in accordance with some embodiments;

FIG. 3 conceptually illustrates exemplary media UI applications provided by the multiple-media application;

FIG. 4 is a flowchart illustrating a method for receiving and storing user presentation settings for combinations of at least two media user interfaces;

FIG. 5A shows an initial screen shot of a primary UI of the multiple-media application;

FIG. 5B shows an exemplary screen shot of media UIs presented using default presentation settings;

FIG. 5C shows an exemplary screen shot of media UIs having modified presentation settings;

FIG. 5D shows exemplary screen shot of different media UIs having modified presentation settings;

FIG. 6 shows an exemplary UIC data structure; and

FIG. 7 is a flowchart illustrating a method for presenting combinations of at least two media user interfaces according to user presentation settings.

### DETAILED DESCRIPTION

In the following description, numerous details are set forth for purpose of explanation. However, one of ordinary skill in the art will realize that the embodiments described herein may be practiced without the use of these specific details. In other instances, well-known structures and devices are shown in block diagram form in order to not obscure the description with unnecessary detail.

The description that follows is divided into three sections. Section I describes a media system environment for multiple media UIs in which some embodiments operate. Section II describes a multiple-media device and multiple-media application for simultaneously presenting combinations of multiple media UIs according to user presentation settings. Section III describes simultaneously presenting combinations of multiple media UIs according to user presentation settings.

### I. Media System Environment for Multiple Media UIs

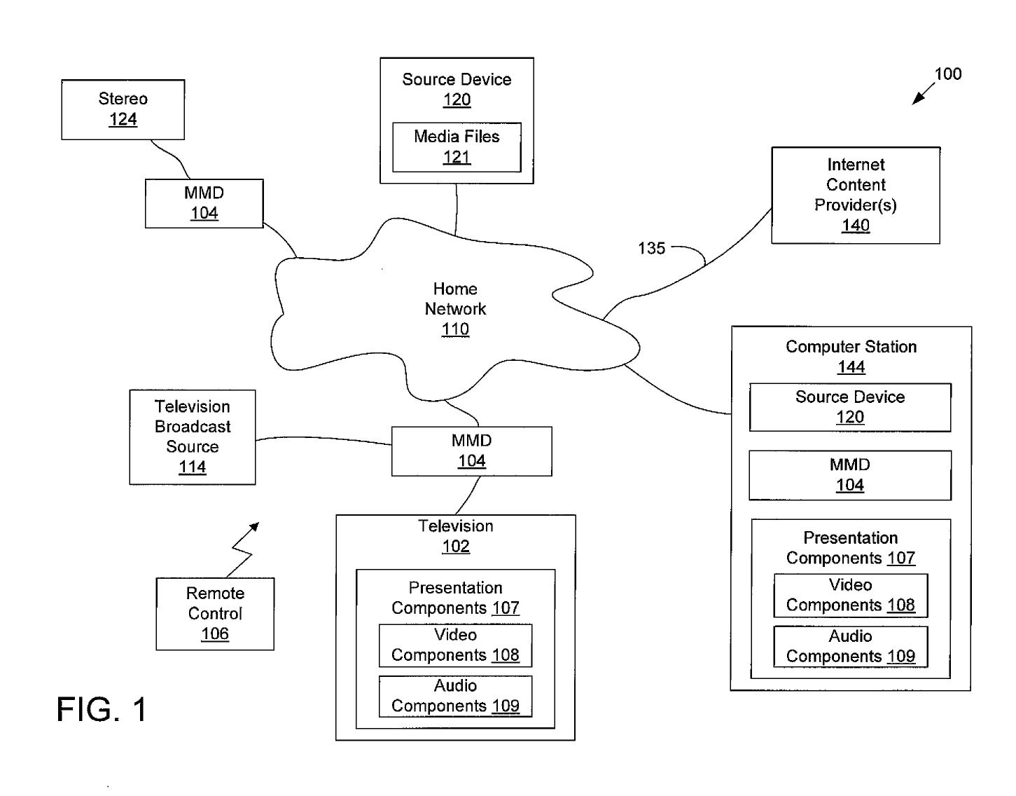

FIG. 1 is a block diagram of an exemplary media system environment 100 in which some embodiments operate. As shown in the FIG. 1, the environment 100 comprises at least one multiple-media device (MMD) 104, one or more local source devices 120, and a computer station 144 coupled through a home network 110 (which is coupled/connected to an external network 135).

Each source device 120 may store personal content comprising a plurality of digital media files 121 of various types. In some embodiments, a source device 120 may store a plurality of different types of media files comprising video, audio, image, and/or gaming media files. In other embodiments, a source device 120 may store other types of media files. A source device 120 may comprise hardware and/or software components configured for storing media files 121. The source device 120 may comprise one or more writable media storage devices, such as disk drives, video tape, magnetic tape, optical devices, CD, DVD, Blu-ray, flash memory, Magnetic Random Access Memory (MRAM), Phase Change RAM (PRAM), a solid state storage device, or another similar device adapted to store data.

A source device 120 may implement a file system to provide directories containing filenames for media files. In some embodiments, the source device 120 and the multiple-media device 104 may be included in a single device, e.g., computer station 144, that is coupled to the home network 110. In other embodiments, a source device 120 and the multiple-media device 104 may comprise separate devices each coupled to the home network 110. In these embodiments, the source device 120 may comprise a dedicated stand-alone storage device, such as a network-attached storage (NAS) or Storage Area Network (SAN) device.

The multiple-media device 104 may comprise a computer device that presents media UIs and media content on presentation components 107. As used herein, “presenting” media UIs or media content may comprise displaying video and/or playing audio of the media UI or media content. The media content may comprise media files received from a source device 120. As such, the multiple-media device 104 also may comprise a decoder for decoding the encoded digital media files. The decoder may be configured for converting the encoded digital data of the media files to analog signals, e.g., digital-to-analog conversion, and pass the analog signals to presentation components 107. The media content may also comprise television broadcast content received from a television broadcast source 114. The media content may further include Internet content received from an Internet content provider 140 (coupled to the home network 110 through an external network 135). In some embodiments, the types of media content include television, Internet, and personal content (comprising video, audio, image, and/or gaming files stored on a local source device).

The multiple-media device 104 is coupled with a television 102 and a computer station, each having presentation components 107. The multiple-media device 104 may present the media content on the presentation components 107 including video components 108 for presenting video content and audio components 109 for presenting audio content of the media content. In particular, the presentation components 107 may be configured for receiving and presenting the analog signals representing the media content, e.g., video and/or audio content. For example, a video component 108 may comprise a screen/display such as a television screen or computer monitor. A variety of displays are contemplated including, for example, a liquid crystal display “LCD”, a light emitting diode (LED), a cathode ray tube (CRT), and/or a plasma type television, etc. As used herein, the terms video component and screen/display may sometimes be used interchangeably. An audio component 109 may include a stereo, speakers, headphones, etc. In some embodiments, the audio components 109 comprises a stereo system 124 coupled with a multiple-media device 104 for presenting audio content.

The multiple-media device 104 may comprise a stand-alone device coupled to the home network 110 and a television 102. In other embodiments, the multiple-media device 104 may be included in a computer station 144 that is coupled to the home network 110. In another embodiment, the multiple-media device 104 is software embodied in specific circuitry that is included inside television 102.

The multiple-media device 104 may receive user input through an input device, such as a remote control device 106. Remote control device 106 includes any device used to wirelessly control television 102 or multiple-media device 104 from a distance. Remote control 106 may include push buttons that provide input selection and include a communication head that transmits user selected inputs to television 102 or multiple-media device 104. For example, the remote control 106 may be used to select commands and input selections of media UIs and media content to the multiple-media device 104.

The home network 110 may comprise a wired, direct connect, and/or wireless system. The home network 110 may be implemented by using, for example, a wired or wireless network, a personal area network (PAN), a local area network (LAN), a wide area network (WAN), a virtual private network (VPN) implemented over a public network such as the Internet, etc., and/or by using radio frequency (RF), infrared (IR), Bluetooth, etc. In other embodiments, the home network 110 may be implemented by using other means. For example, the home network 110 may comprise a network implemented in accordance with standards, such as Ethernet 10/100/1000 over Category 5 or 6, HPNA, Home Plug, IEEE 802.x, IEEE 1394, USB 1.1, 2.0, etc.

The multiple-media device 100 may also be coupled to Internet content providers 140 (located external to the home network 110) for receiving and presenting Internet content. The multiple-media device 100 may access such content providers 140, for example, for receiving webpages, streaming content, and/or downloading content comprising externally located media files, which may then be stored to a source device 120. The multiple-media device 100 may be coupled to the content providers 140 through an external network 135 for example, the Internet, private distribution networks, etc. In other embodiments, the external content may be transmitted and/or broadcasted. For example, the multiple-media device 100 may access external content through a data casting service including, for instance, data modulated and transmitted by using RF, microwave, satellite, or another transmission technology.

### II. Multiple-Media Device and Multiple-Media Application

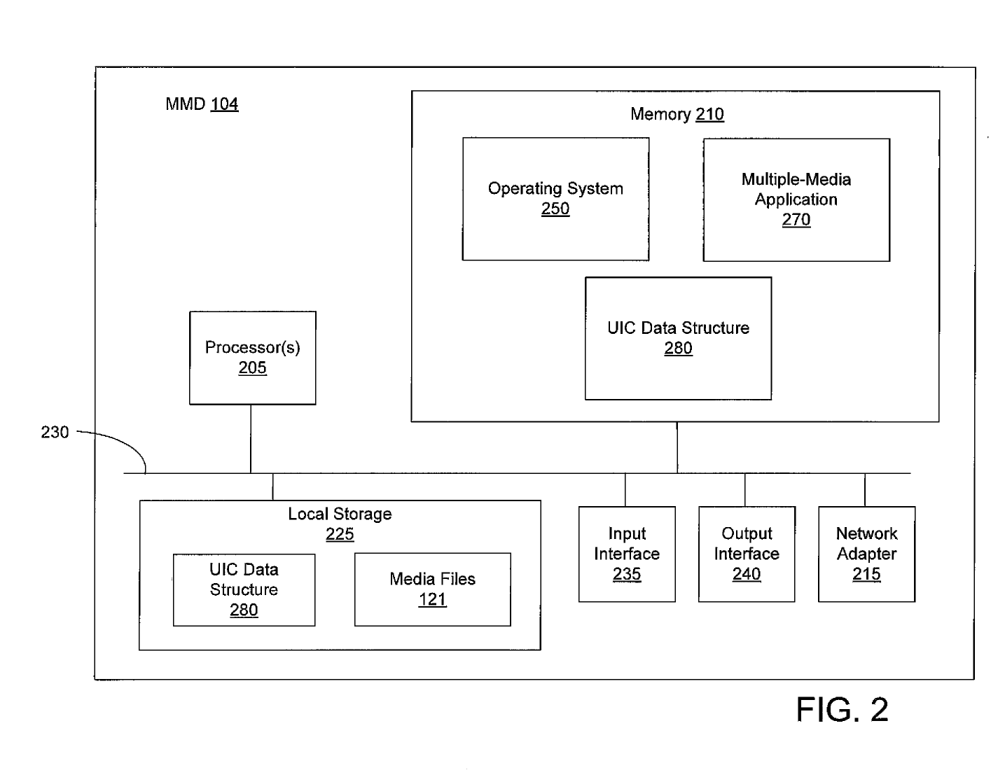

In some embodiments, a multiple-media device (MMD) 104 may comprise a computer device comprising hardware and/or software components. FIG. 2 is a diagram illustrating exemplary hardware and software components of a multiple-media device 104, in accordance with some embodiments. The multiple-media device 104 comprises processor(s) 205, a memory 210, a network adapter 215, a local storage 225, an input interface 235, and an output interface 240, coupled by a bus 230.

The processors 205 are the central processing units (CPUs) of the multiple-media device 104. The processors 205 may include programmable general-purpose or special-purpose microprocessors, digital signal processors (DSPs), programmable controllers, application specific integrated circuits (ASICs), programmable logic devices (PLDs), or the like, or a combination of such devices.

A network adapter 215 may comprise mechanical, electrical and signaling circuitry needed to couple the multiple-media device 104 to the home network 110 and to receive and transmit data over the home network 110. For example, the network adapter 215 may comprise a network port controller, e.g., Ethernet cards, for receiving and transmitting data over a network 110. For example, a network adapter 215 may be used to couple the multiple-media device 104 to a source device 120 through the home network 110.

The local storage 225 may comprise a non-volatile storage device that stores information within the multiple-media device 104. The multiple-media device 104 loads information stored on the local storage 225 into a memory 210 from which the information is accessed by the processors 205. In some embodiments, the UIC data structure 280 is stored on local storage 225. In some embodiments, the local storage 225 may also store media files 121 and therefore comprise or function as a source device 120.

The memory 210 comprises storage locations that are addressable by the processor 205 for storing software program code. The processor 205 and adapters may, in turn, comprise processing elements and/or logic circuitry configured to execute the software code. For example, the memory 210 may be a random access memory (RAM), a read-only memory (ROM), or the like. In some embodiments, the memory 210 stores instructions and/or data for an operating system 250, a multiple-media application 270, and a UIC data structure 280.

The input interface 235 may coupled/connect to input devices that enable a user to input selections to the multiple-media application 270 and communicate information and select commands to the MMD 104. The input devices may include the remote control 106, alphanumeric keyboards, cursor-controllers, etc. The output interface 240 may coupled/connect to output devices. The output devices may comprise presentation components 107, including video components 108 (such as a display/screen) and audio components 109 (such as speakers) that present media UIs and media content.

In embodiments described below, media user interfaces, such as graphical UIs (GUI), may be implemented through which a user can interact and select various operations to be performed. For example, the user may use an input device to input information to the multiple-media application 270 through a graphical UI (GUI) displayed on a screen of a video component 108. Through the graphical UI, the user may select icons and/or menu items for selecting media UIs or media content to be presented simultaneously in multiple windows on presentation components 107. Through the UI, the user may also interact with the various windows displayed in the UI (e.g., to select and move/position and size a particular window). In some embodiments, the multiple displayed windows may be moved around by the user independently in the UI and may overlap one another. When used in conjunction with a television 102, MMD 104 further adds additional functions to television 102. In some embodiments, MMD 104 enables television 102 to display multiple media UIs in different windows.

### III. Presenting Multiple Media UIs

### A. Overview

In general, the multiple-media application 270 may provide a plurality of media UI applications for selecting media content. The multiple-media application 270 may also comprise a UI application for receiving user selections for presentation settings for combinations of at least two media UIs to be presented simultaneously, and storing the received presentation settings to the UIC data structure 280. The multiple-media application 270 may then later receive user selections for a particular combination of at least two media UIs to be presented simultaneously and then present the at least two media UIs according to the presentation settings for the particular combination stored in the UIC data structure 280.

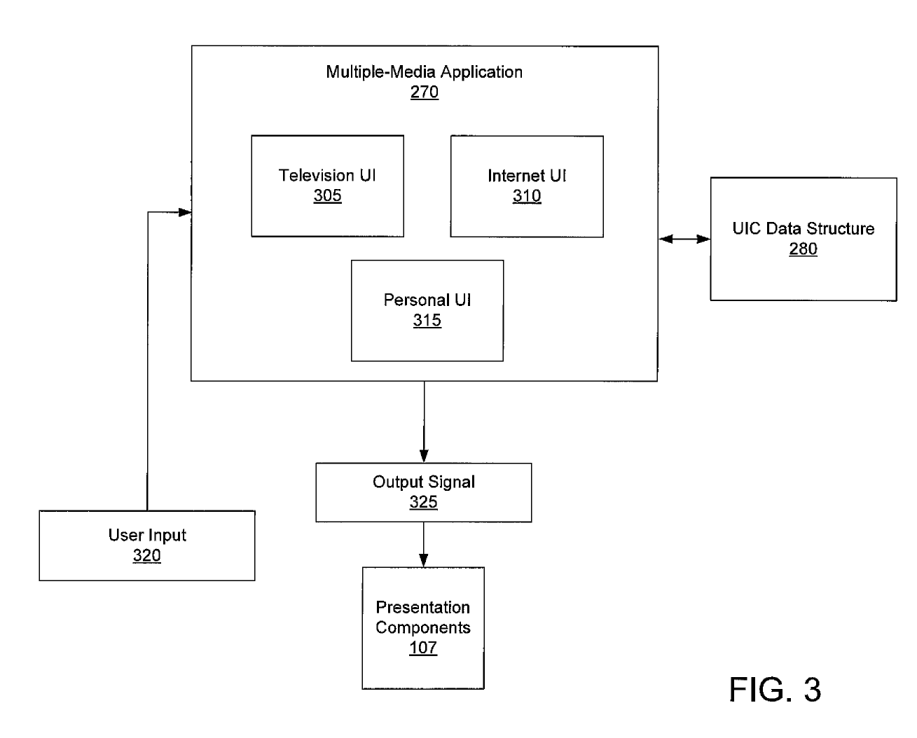

FIG. 3 conceptually illustrates exemplary media UI applications that may be provided by the multiple-media application 270. In the example of FIG. 3, the multiple-media application 270 may provide a television UI 305 for selecting and presenting television content, an Internet UI 310 for selecting and presenting Internet content, and/or a personal UI 315 for selecting and presenting personal content. The television UI 305 may be used for selecting and presenting television content such as television channels. The Internet UI 310 may comprise, for example, an email or browser application, for selecting and presenting Internet content (e.g., webpage, streaming content, and/or downloading content, etc.). The personal UI 315 may be used for selecting and presenting personal content (e.g., video, audio, image, or gaming files stored on a source device 120).

Each such media UI may display selectable icons/items representing various media content for selecting the media content for presentation in the corresponding UI. Upon a media UI receiving a selection of an icon/item representing a particular media content from a user, the media UI may receive the selected media content from the appropriate source and present the selected media content in the window of the media UI.

For example, the television UI may display selectable icons/items representing various television channels. Upon the television UI receiving a selection of an icon/item representing a particular television channel from a user, the television UI may receive the selected television channel from the television broadcast source 114 and present the selected television channel in the window of the television UI.

For example, the Internet UI may display selectable icons/items representing various Internet content. Upon the Internet UI receiving a selection of an icon/item representing a particular Internet content from a user, the Internet UI may receive the selected Internet content from an Internet content provider 140 and present the selected Internet content in the window of the Internet UI.

For example, the personal UI may display selectable icons/items representing various media files stored on a source device. Upon the personal UI receiving a selection of an icon/item representing a particular media file from a user, the personal UI may receive the selected media file from the source device and present the selected media file in the window of the personal UI.

The multiple-media application 270 may receive input selections 320 from a user through an input device, such as the remote control 106. The multiple-media application 270 is configured to receive user input 320 that selects multiple media UIs to be presented simultaneously. The multiple-media application 270 may then simultaneously present the multiple media UIs by producing an output signal 325 that is sent to presentation components 107 which present the multiple media UIs. The output signal 325 may comprise video and audio signals that are output to presentation components 107 comprising video and audio components. For example, the output signal 325 may comprise a television signal sent to a television 102.

The multiple-media application 270 may also receive user input 320 comprising configuration of presentation settings for combinations of at least two media UIs. The multiple-media application 270 may store the received user presentation settings to the UIC data structure 280. The multiple-media application 270 may then later receive user input 320 selecting a particular combination of at least two media UIs to be presented simultaneously. If so, the multiple-media application 270 presents the at least two media UIs according to presentation settings for the particular combination retrieved from the UIC data structure 280.

### B. Receiving and Storing User Presentation Settings

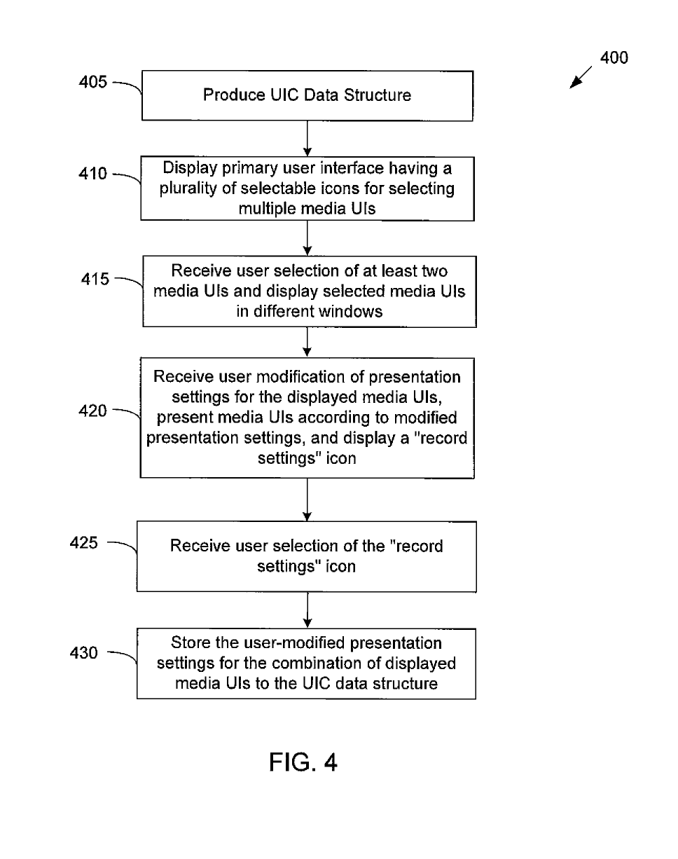

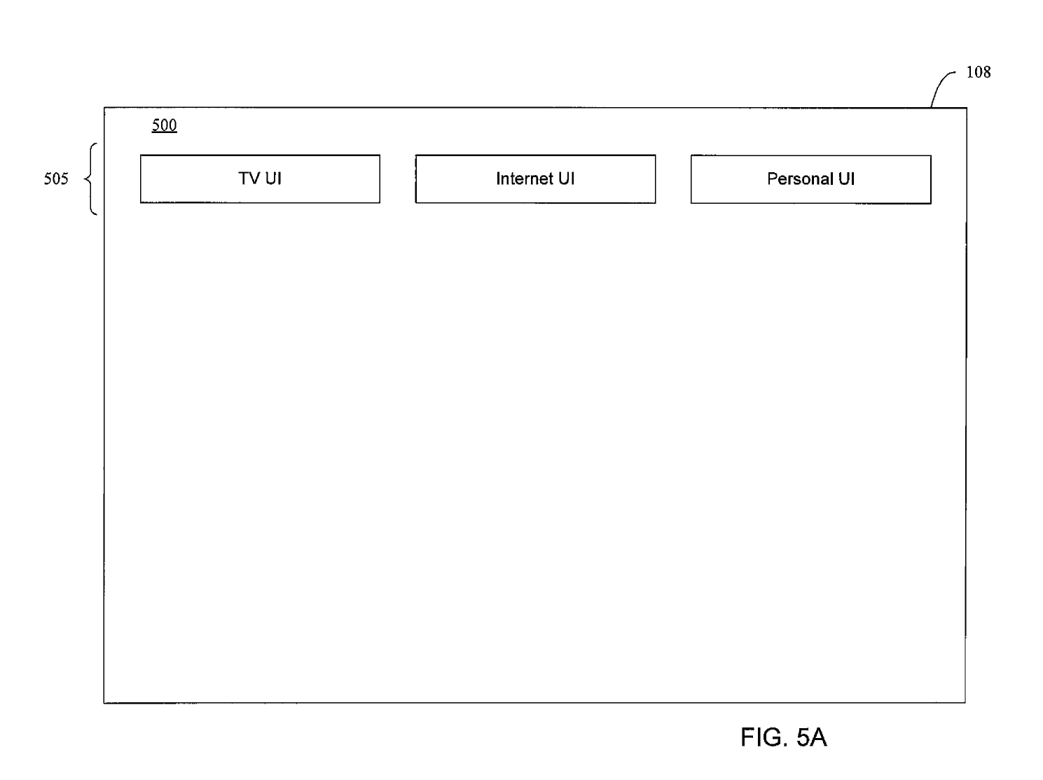

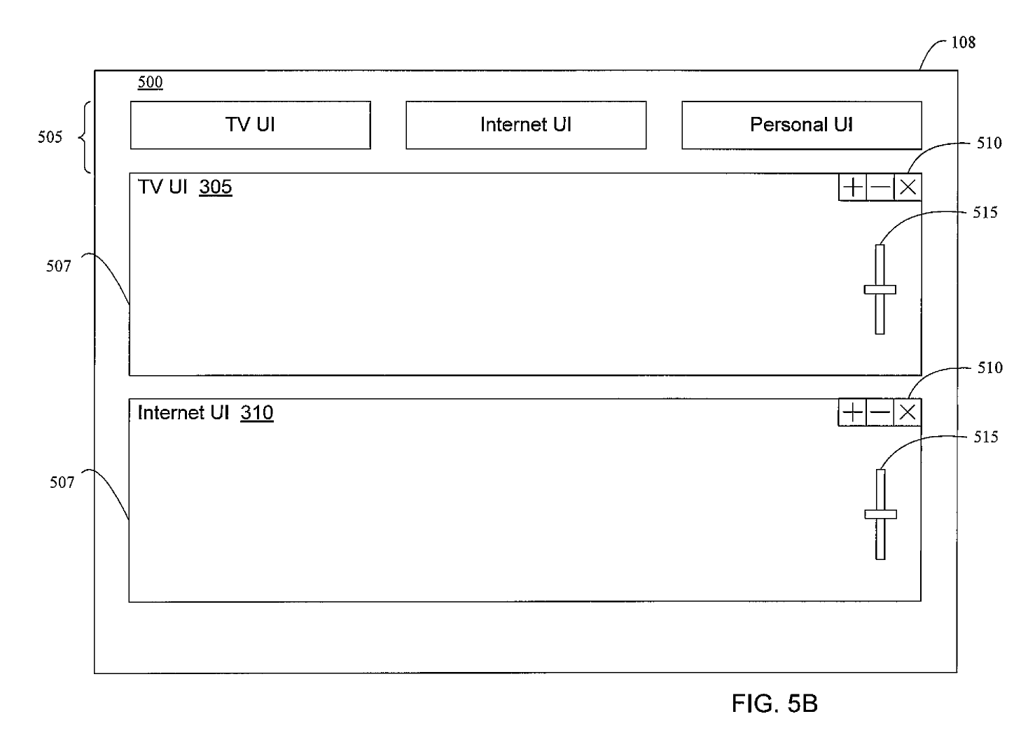

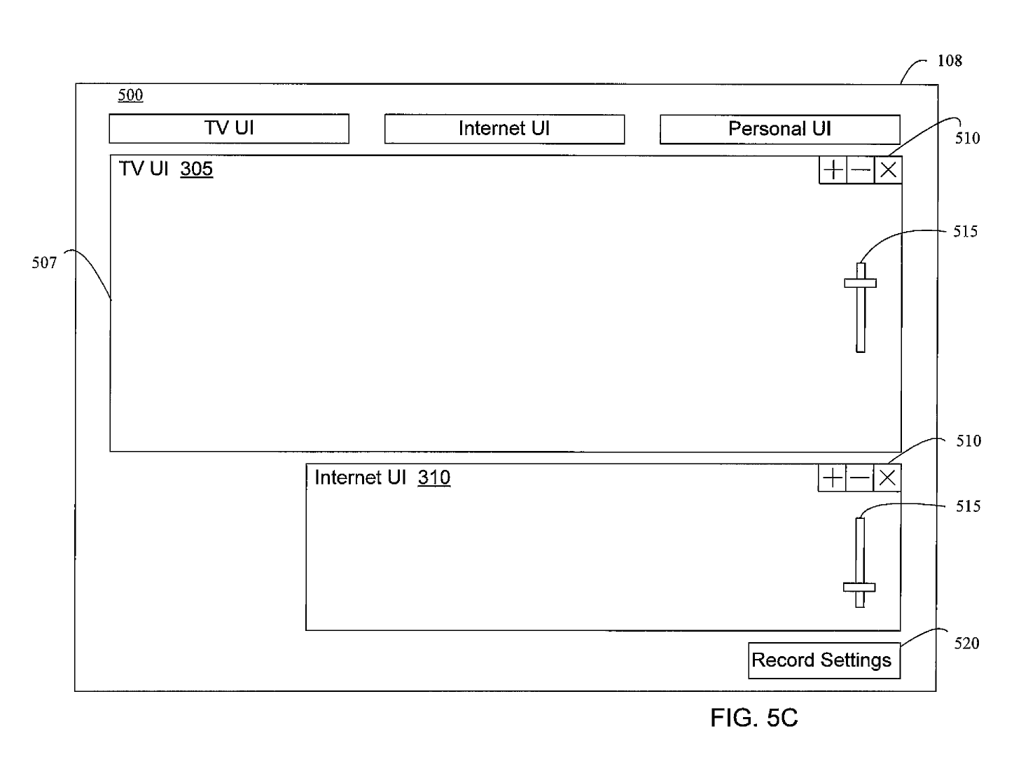

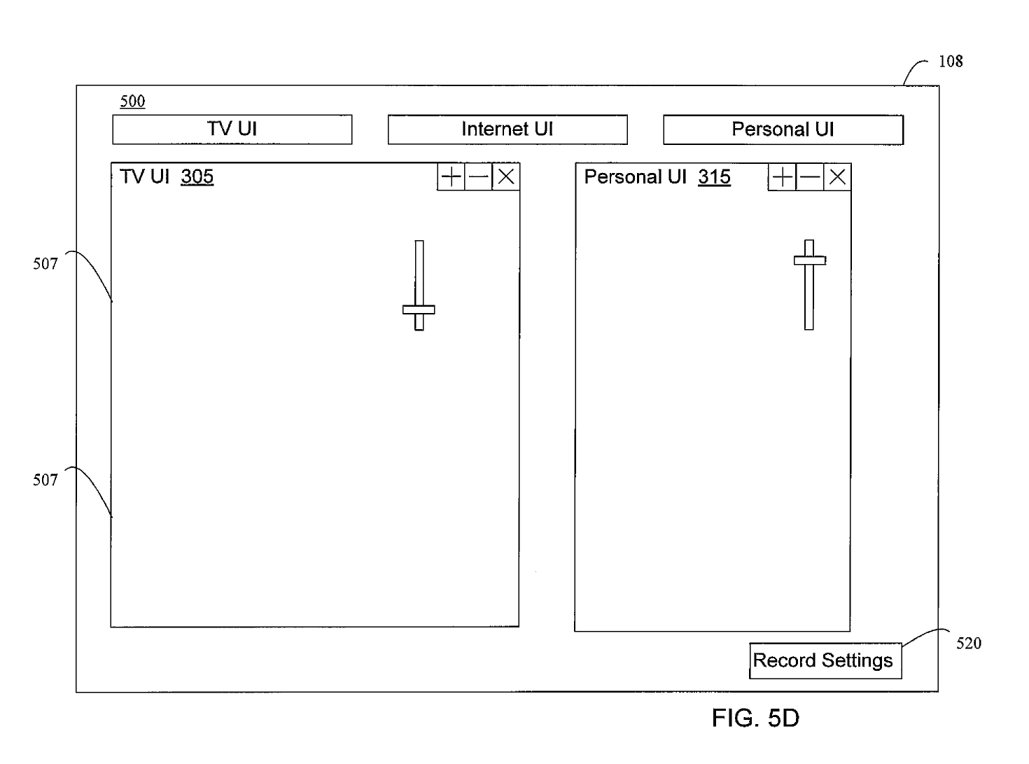

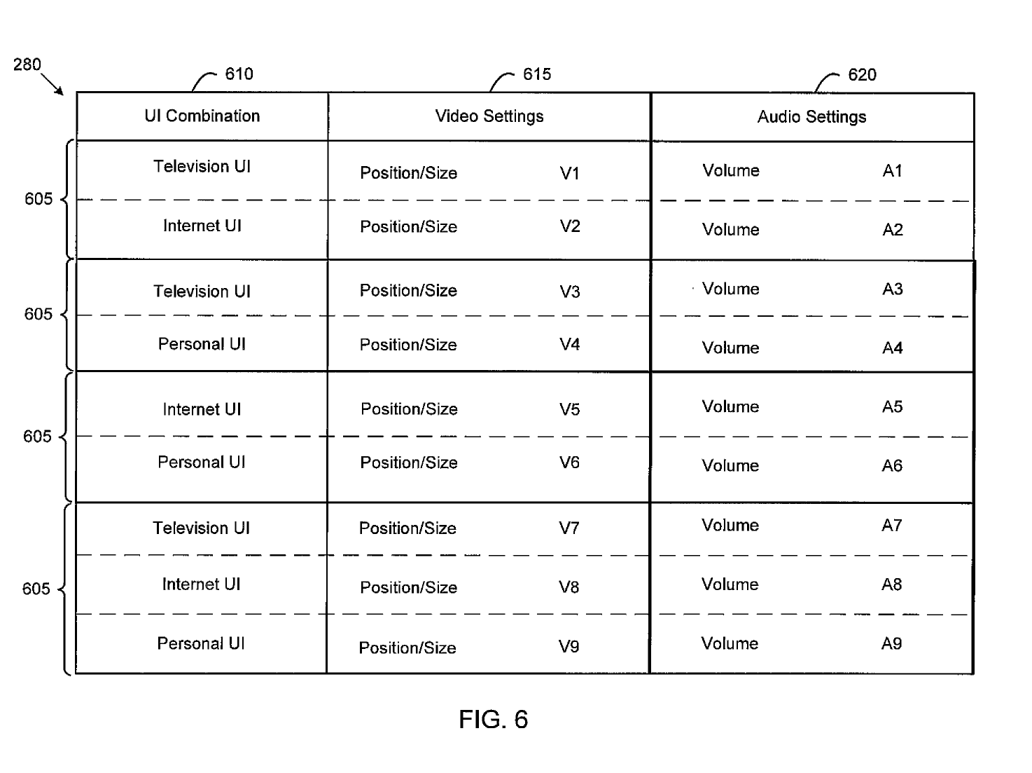

FIG. 4 is a flowchart illustrating a method 400 for receiving and storing presentation settings for combinations of at least two media user interfaces. The method 400 of FIG. 4 is described in relation to FIGS. 5A-D which conceptually illustrate steps of the method 400 and FIG. 6 which shows an exemplary UIC data structure 280. In some embodiments, some of the steps of the method 400 may be performed by the multiple-media application 270 on video components 108 (screen/display) and audio components 109. The order and number of steps of the method 400 is for illustrative purposes only and, in other embodiments, a different order and/or number of steps are used.

The method 400 begins by producing (at a step 405) the UIC data structure 280 on the multiple-media device 104, e.g., as stored in memory 210 and/or in local storage 225. The method 400 then displays (at a step 410) on a screen 108 a primary user interface for selecting multiple media UIs. FIG. 5A shows an initial screen shot of the primary UI 500 of the multiple-media application 270 as displayed on a screen/display 108. As shown in the example of FIG. 5A, the primary UI 500 displays a plurality of selectable icons 505 for selecting a plurality of media UIs, including a selectable icon for a television UI, a selectable icon for an Internet UI, and a selectable icon for a personal UI.

The method 400 then receives (at a step 415) a user input selecting at least two selectable icons 505 for at least two corresponding media UIs and displays (on the screen/display) the at least two selected media UIs in at least two different windows within the primary UI 500. The method 400 may present the at least two selected media UIs using default presentation settings.

FIG. 5B shows an exemplary screen shot of media UIs presented using default presentation settings. As shown in the example of FIG. 5B, the method has received (at a step 415) a user input selecting the icon 505 for the television UI 305 and the icon 505 for the Internet UI 310 and has presented the television UI 305 in a first window 507 and the Internet UI 310 in a second window 507 within the primary UI 500 on the screen 108. Note that each window 507 presented for each media UI comprises selectable window icons 510 and an audio volume interface 515. The selectable window icons 510 may include icons for maximizing the window (“+”), minimizing the window (“−”), or closing the window (“X”) for the media UI. The audio volume interface 515 may be used to adjust the audio volume setting for media content that is presented through the media UI. In the example of FIG. 5B, the default presentation settings may specify that each media UI be presented in the same size window and have the same audio volume setting (e.g., middle volume).

The method 400 then receives (at a step 420) user input that modifies one or more presentation settings for the at least two displayed media UN, presents the at least two media UIs according to the modified presentation settings, and displays a “record settings” icon 520. In some embodiments, the multiple displayed windows may be moved around by the user independently on the screen 108 within the primary user interface 500 and may overlap one another. In some embodiments, presentation settings for a media UI comprise video and/or audio settings. Video settings for a media UI may include the location/position and size of the media UI window shown on the screen/display. Audio settings for a media UI may include the audio volume setting (e.g., high, low, mute volume, etc.) of media content presented through the media UI.

FIG. 5C shows an exemplary screen shot of media UIs having modified presentation settings. As shown in the example of FIG. 5C, the method has received (at a step 420) user inputs that modify the position/location and the size of each of the windows 507 and the audio volume settings for both the television UI 305 and the Internet UI 310. In some embodiments, upon receiving user modifications to one or more presentation settings for at least two media UIs, the method displays a “record settings” icon 520 for storing the user-modified presentation settings for the combination of the at least two media UIs. As such, upon receiving user modifications to one or more presentation settings for the television UI 305 and the Internet UI 310, the method displays a “record settings” icon 520 for storing the user-modified presentation settings for the combination of the television UI 305 and the Internet UI 310.

FIG. 5D shows another exemplary screen shot of different media UIs having modified presentation settings. As shown in the example of FIG. 5D, the method has received (at a step 415) a user input selecting the icons 505 for the television UI 305 and the personal UI 315 and received (at a step 420) user inputs that modify the position/location and size of windows 507 and the audio volume settings for both the television UI 305 and the personal UI 315. Upon receiving user modifications to one or more presentation settings for the television UI 305 and the personal UI 315, the method displays a “record settings” icon 520 for storing the user-modified presentation settings for the combination of the television UI 305 and the personal UI 315.

The method 400 then receives (at a step 425) user input that selects the “record settings” icon 520. In response, the method then stores (at a step 430) the user-modified presentation settings for the combination of the at least two displayed media UIs to the UIC data structure 280 as an entry in the UIC data structure 280. The method 400 then ends. Note that the method 400 may be repeated multiple times to receive and store presentation settings for a plurality of combinations of at least two media UIs.

FIG. 6 shows an exemplary UIC data structure 280. As shown in FIG. 6, the UIC data structure 280 comprises a plurality of UI combination entries 605. In general, each UI combination entry 605 may represent a particular combination of at least two media UIs and specify presentation settings to be used when the particular combination of media UIs is to be presented simultaneously. In some embodiments, each media UI in a UI combination entry 605 may present a different type of media content from another media UI in the same entry 605.

In some embodiments, each UI combination entry 605 may comprise a plurality of data fields, including a UI combination data field 610 for specifying the media UIs in the UI combination, a video settings data field 615 for specifying the video settings for the UI combination, and an audio settings data field 615 for specifying the audio settings for the UI combination. Note that each UI combination entry 605 may separately specify presentation settings (video and audio settings) for each media UI in the combination of media UIs that are represented by the entry 605.

The video settings data field 615 may specify, for each media UI in the UI combination, the position and size settings for displaying the window of the media UI within the primary UI 500 on the screen 108. The position and size settings of a UI window on the screen 108 may be specified in various ways known in the art, and are represented generally as “V1,” “V2,”, etc., which may each comprise a set of one or more values. For example, the video settings may specify X and Y coordinates of an upper-left corner and X and Y coordinates of a lower right corner of the window displaying the media UI, thus giving position and size settings for the window. The audio settings data field 620 may specify, for each media UI in the UI combination, the audio volume setting used for media content that is presented through the media UI.

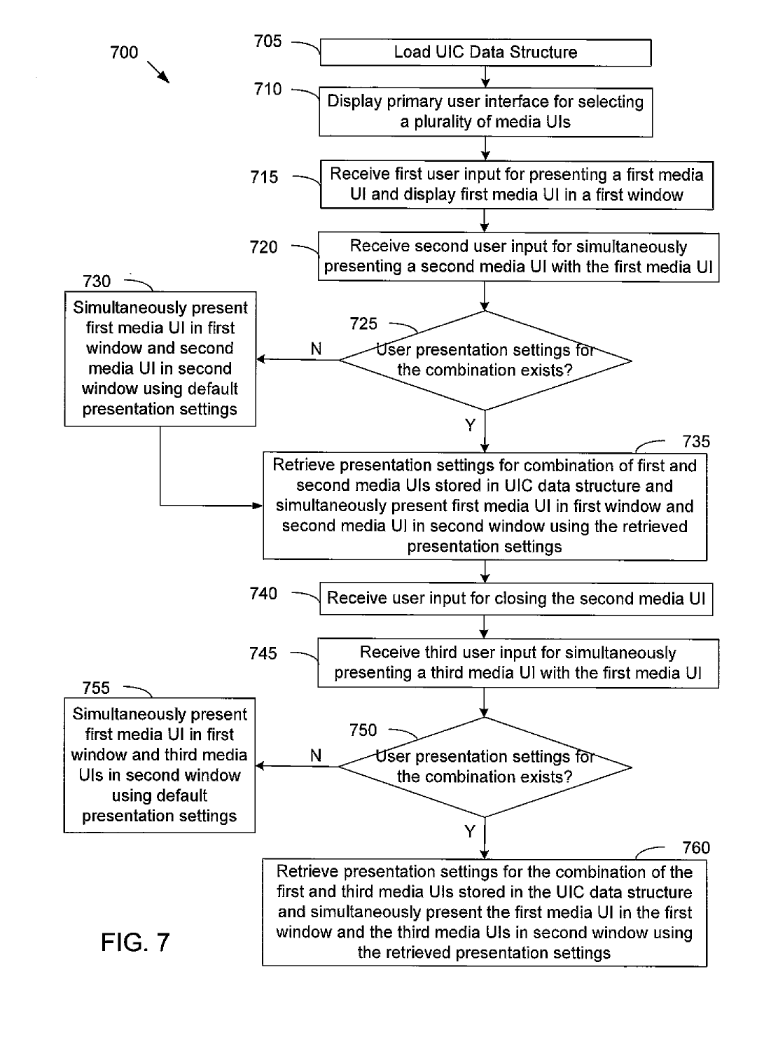

In the example of FIG. 6, the UIC data structure 280 stores presentation settings to be later used when simultaneously presenting combinations of media UIs (as discussed below in relation to FIG. 7). Note that when a combination of two or more media UIs are later selected to be presented simultaneously, the presentation settings for the combination of media UIs retrieved from the UIC data structure 280 are specific to the particular combination of media UIs that are selected to be presented simultaneously.

For example, for simultaneously presenting the combination of the television UI 305 and the Internet UI 310, the UIC data structure 280 may specify that a first set of presentation settings are to be used (e.g., video settings V1 and audio settings A1 for the television UI 305 and video settings V2 and audio settings A2 for the Internet UI 310). However, for simultaneously presenting the combination of the television UI 305 and the personal UI 315, the UIC data structure 280 may specify that a second different set of presentation settings are to be used (e.g., video settings V3 and audio settings A3 for the television UI 305 and video settings V4 and audio settings A4 for the personal UI 315). Also note that a UI combination may comprise more than two media UIs (e.g., the television UI 305, the Internet UI 310, and the personal UI 315).

As such, the user may define and store desired presentation settings for particular combinations of media UIs. The presentation settings may then be automatically retrieved and used (as discussed below in relation to FIG. 7) whenever the user selects the particular combination of media UIs to be presented simultaneously, without having to re-establish the presentation settings of the media UIs each time the particular combination of media UIs are selected.

### C. Using Stored User Presentation Settings

FIG. 7 is a flowchart illustrating a method 700 for presenting combinations of at least two media user interfaces according to user presentation settings. The method 700 of FIG. 7 is described in relation to FIGS. 5A-D which conceptually illustrate steps of the method 700 and FIG. 6 which shows an exemplary UIC data structure 280. In some embodiments, some of the steps of the method 700 may be performed by the multiple-media application 270 on video components 108 (such as a screen/display) and audio components 109. The order and number of steps of the method 700 is for illustrative purposes only and, in other embodiments, a different order and/or number of steps are used.

The method 700 begins by loading (at a step 705) the UIC data structure 280 into memory 210. The method 700 then displays (at a step 710) on a screen 108 the primary user interface 500 having a plurality of selectable icons 505 for selecting a plurality of media UIs (as shown in FIG. 5A).

The method 700 then receives (at a step 715) a first user input selecting a first selectable icon 505 for presenting a first media UI and displays on the screen 108 the first selected media UI in a first window within the primary UI 500. The method 700 may present the first selected media UI using default presentation settings (e.g., display the first window in full size mode with the audio volume set to middle).

The method 700 then receives (at a step 720) a second user input selecting a second selectable icon 505 for simultaneously presenting a second media UI with the first media UI. In some embodiments, upon receiving a user input for simultaneously presenting a combination of two or more media UIs, the method 700 may first retrieve presentation settings for the combination of media UIs from the UIC data structure 280 and then present the particular combination of media UIs according to the retrieved presentation settings.

As such upon receiving the second user input for simultaneously presenting the second media UI with the first media UI, the method 700 may determine (at a step 725) whether the UIC data structure 280 contains user presentation settings for the particular combination of the first and second media UIs. The method 700 may do so by examining the UI combination data fields 610 of the UI combination entries 605 stored in the UIC data structure 280 (shown in FIG. 6) to determine whether a UI combination entry 605 for the particular combination of the first and second media UIs has been produced and stored to the UIC data structure 280.

If not (at 725—No), the method 700 simultaneously presents (at a step 730) the first selected media UI in the first window and the second selected media UI in a second window using default presentation settings (as shown in the example of FIG. 5B). The method 700 then proceeds to step 740. If so (at 725—Yes), the method 700 retrieves (at a step 735) the presentation settings for the particular combination of the first and second media UIs stored in the UIC data structure 280, and simultaneously presents the first selected media UI in the first window and the second selected media UI in a second window using the retrieved presentation settings (as shown in the example of FIG. 5C).

The method 700 then receives (at a step 740) a user input for closing the second media UI (e.g., receiving a selection of the “X” selectable window icon 510 in the second media UI for closing the second window). The method 700 then receives (at a step 745) a third user input selecting a third selectable icon 505 for simultaneously presenting a third media UI with the first media UI. The method 700 then determines (at a step 750) whether the UIC data structure 280 contains user presentation settings for the particular combination of the first and third media UIs.

If not (at 745—No), the method 700 simultaneously presents (at a step 755) the first selected media UI in the first window and the third selected media UIs in a second window using default presentation settings. If so (at 745—Yes), the method 700 retrieves (at a step 760) the presentation settings for the particular combination of the first and third media UIs stored in the UIC data structure 280, and simultaneously presents the first selected media UI in the first window and the third selected media UIs in a second window using the retrieved presentation settings for the particular combination of the first and third media UIs (as shown in the example of FIG. 5D). In some embodiments, the presentation settings for the combination of the first and third media UIs are different than the presentation settings for the combination of the first and second media UIs (applied at step 735).

Note that each of the first, second, and third media UIs may display selectable icons/items representing various media content for selecting the media content for presentation in the corresponding UI. For example, the first, second, and third media UIs may comprise a television UI, Internet UI, and personal UI, respectively. As such, the television UI may display selectable icons/items representing various television channels, receive selected television channels from a television broadcast source 114, and present the television content in the window of the television UI. The Internet UI may display selectable icons/items representing various Internet content, receive selected Internet content from a content provider 140, and present the selected Internet content in the window of the Internet UI. The personal UI may display selectable icons/items representing various personal content, receive selected personal content from a source device, and present the selected personal content in the window of the personal UI.

For example, an embodiment may provide a set of video settings 615 as illustrated in FIG. 6. In other embodiments, video settings may include other video settings/parameters such as position, size, resolution or television standard (e.g., lower definition, standard definition, high definition, SECAM, PAL, NTSC, LumalChroma, S-Video, composite video, component video), frame or field rate, brightness, contrast, color saturation, hue, sharpness, gamma curve, aspect ratio, or any combination thereof.

An embodiment may provide a set of audio settings or parameters, which may include volume, equalization settings (such as settings for bass, midrange, and/or treble), audio level compression, audio limiting, or any combination thereof. For example, providing a reduced dynamic range via an automatic audio level adjustment system/algorithm may be implemented when a program is switched to a commercial. In these embodiments, an automatic audio level system may provide the user with a more constant average sound level. For example, the normally very loud commercial relative to the audio level of the program usually causes the user to manually turn down the audio signal during the commercial and then manually turn up the audio level after the commercial ends.

Thus, in one embodiment a stored setting for audio levels such as a first audio (level) setting for video programs and a second audio (level) setting are entered and/or stored by the user. The user may update any of these two audio settings. When a program transitions to a commercial, usually the video signal fades to black, or there is a logo that appears just before the start of a commercial. By using a fade to black frame/field detector or a logo detector, or any metadata, data, or signal sent by the program provider or system operator to “flag” provide a signal indicative of the presence of a commercial (or lack of), the audio level may be controlled or enabled/disabled to control the audio level (separately) during the video program and/or during commercial breaks. Thus, one embodiment includes storing audio settings for various types of television programs and executing these settings in a television set or media player or recorder.

In another embodiment, certain audio and/or video settings may be received and stored for later use when selecting television channels and/or programs. For example, based on received user inputs, the MMD 104 may store and associate one or more audio or video settings to correspond to one or more channels or programs, or any combination thereof. For example, the MMD 104 may receive (from a user) and store a first set of audio and/or video settings/parameters for a first channel or first program, and a second set of audio and/or video settings/parameters for a second channel or second program. The audio and/or video settings may be stored in the UIC data structure 280 (e.g., stored on local storage 225).

Upon later receiving a selection of a television channel or program from a user, the MMD 104 may retrieve and apply the audio and/or video settings corresponding to the selected television channel or program, and cause the selected television channel or program to be displayed on the television monitor with the corresponding audio and/or video settings. As such, the MMD 104 may display, on a television monitor, the selected channel or program according to the retrieved audio or video settings. In some embodiments, rather than receiving settings from a user, the MMD 104 may receive and store a settings file comprising audio and/or video settings for one or more channels or programs. The MMD 104 may receive the settings file through a network (e.g., from an Internet content provider 140 through the external network 135). The settings file may be stored in the UIC data structure 280 (e.g., stored on local storage 225).

It should be noted another embodiment may include a first user sending any of the stored settings to a second or another user. This is particularly useful if two or more people have similar equipment. For example, two people have brand “X” television sets or media device. A first person can find or set up an optimal audio and/or video settings file and send/provide the settings file to a second person who will utilize this file to set up the brand “X” device quickly (and without having to go through the manual set up procedure of the first person). The file may include any adjustment parameter previously mentioned.

In another embodiment, one or more settings are stored. For example, in FIG. 6, the user may display a “current” or last settings, but can go back (historically) to an older setting (e.g., a time before (current setting) measured in seconds, minutes, hours, days, weeks, years, and/or the like). That is, any of the devices mentioned may include a log or history of settings, or settings as a function of time.

It should be noted that an embodiment may include assigning a set of settings to a particular time and date. For example, if a particular date includes viewing primarily sporting events, a set of parameter is recalled from a file, which sets optimally video and/or audio settings for sports events. For instance, the video setting may include primarily a wide screen aspect ratio and/or audio setting that includes audio level compression. In another example, one or more set of settings entered by a user is associated with a time stamp such as seconds, minutes, hour, day, and/or year.

An embodiment includes the capability to access any of the settings, which may be received or and/or stored in a Home Network such as indicated by one or more blocks of FIG. 1, or another type of audio or video (home) entertainment system. For example, a remote control may have one or more pre-programmed settings of parameter for video and/or audio quality. Depending on the program viewed, a user can quickly enter a pre-programmed setting (e.g., for optimal viewing and/or listening).

In another embodiment, a computer linked to an audio and/or video system may allow a separate video monitor and/or speaker/headphone as to allow the user to try out or enter one or more settings in a preview mode. If the preview mode settings via a separate audio/video monitor are desired or selected, then the preview mode settings may be sent and/or applied to the television set or media system. In a manner of using a separate audio and/or video monitor, the main viewing is not interrupted while setting of video and audio parameters are being explored.

In another embodiment, a custom white balance setting may be included as part of the video settings parameter. For example, a cursor or pointer may be located in an area (e.g., a television line and/or one or more pixels) of the displayed video program known to be white, gray, or black. Should there be a color cast in this displayed area, a color algorithm is implemented to remove the color cast by readjusting any combination of the color channels (e.g., red, green, blue) of the video signal. For example, a white or gray area would normally include a signal that has a combination of: K(0.59Green+0.30Red+0.11Blue). A white or gray area with a color cast will provide a signal of: K(K1Green+K2Red+K3Blue), wherein K1 is not equal to 0.59 or K2 is not equal to 0.30 or K3 is not equal 0.11. The color correction algorithm will change one or more coefficients, K1, K2, and/or K3 to provide a color corrected (displayed) signal. This custom color correction setting may be provided or stored for use in devices that is associated with one or more video programs that includes a color cast.

Or alternatively, a settings file may provide or adapt a selected color temperature or color balance based on a selected channel or video program. For instance, in the movie “South Pacific” the production studio had intentionally created a brownish or yellowish tint throughout the film, so one parameter of a settings file, may include to add more blue to counter or reduce the yellowish tint (e.g., of the movie “South Pacific”).

Thus, a library of settings files may be associated with particular programs, movies, and/or displayed material to at least alter the color balance. For example, when a program, network, and/or channel is selected, a file is received or retrieved to provide a “custom” video and/or audio set up to provide an improved (or special effects/transformed) version from the standard video and/or audio settings when viewing via a media player, receiver, tuner, digital network, and/or display. It should be noted that one or more settings files may be distributed via Home Network, generic digital network, cable, Internet, fiber or optical communication system, wireless or wired system, broadcast, phone system, WiFi, WiMax, etc.

Another embodiment may include files relating to black level adjustment. For example, plasma displays, cathode ray tube displays, digital light projection displays, liquid crystal displays have different gamma and/or black level characteristics. It should be noted that each display or television set may have inadequate bass and/or treble audio response in their internal loud speakers. So, one or more settings files may include audio frequency equalization for providing a better sounding experience in these displays. A database of files based on optimizing video and/or audio quality of displays may be utilized in a particular display or distributed or stored such that other users can load the settings files into their displays or media devices for improved video and/or audio performance.

In another embodiment, devices such as television sets, displays, set top boxes, cell phones, media players, receivers, tuners, digital network devices, storage devices, and/or the like may accept one or more settings files (e.g., via conversion to data, metadata, vertical blanking interval data, and/or MPEG data) to adjust/set for audio and/or video parameters. For example, any of the devices may include reader and/or a processing unit to interpret/read commands from a settings file, wherein one or more commands performs a transformation and/or change in one or more audio and/or video parameters of the device(s).

Alternatively, a settings file (including video and/or audio (signal) parameters) may be transformed into an executable program, applet, and/or widget. For example, a widget may appear in a location of a display or television such that enabling the widget or applet executes parametric adjustments or changes for video and/or audio settings. A widget or applet may be provided via a storage medium and/or by transmission (e.g., from one device to another device or from a broadcast).

Some embodiments may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art would understand that information may be represented using any of a variety of different technologies and techniques.

Some embodiments include a computer program product comprising a computer readable medium (media) having instructions stored thereon/in and, when executed (e.g., by a processor), perform methods, techniques, or embodiments described herein, the computer readable medium comprising sets of instructions for performing various steps of the methods, techniques, or embodiments described herein. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMS, EPROMs, EEPROMs, DRAMs, VRAMs, flash memory devices (including flash cards), magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments,

Those of skill would further appreciate that the various illustrative logical blocks, modules, circuits, techniques, or method steps of embodiments described herein may be implemented as electronic hardware, computer software, or combinations of both. To illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the embodiments described herein.

The various illustrative logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The algorithm, techniques, processes, or methods described in connection with embodiments disclosed herein may be embodied directly in hardware, in software executed by a processor, or in a combination of the two. In some embodiments, any software application, program, tool, module, or layer described herein may comprise an engine comprising hardware and/or software configured to perform embodiments described herein. In general, functions of a software application, program, tool, module, or layer described herein may be embodied directly in hardware, or embodied as software executed by a processor, or embodied as a combination of the two. A software application, layer, or module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read data from, and write data to, the storage medium. In the alternative, the storage medium may be integral to the processor. The processor and the storage medium may reside in an ASIC. The ASIC may reside in a user device. In the alternative, the processor and the storage medium may reside as discrete components in a user device.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

What is claimed is:

1. A media system for presenting multiple media user interfaces (UIs), the media system comprising:
a memory for storing a data structure comprising a plurality of entries, each entry specifying presentation settings, received from a user, for a combination of at least two media UIs being presented simultaneously; and
a multiple-media device configured for:
providing a plurality of media UIs;
receiving a selection of a first media UI and a second media UI to be presented simultaneously;
retrieving presentation settings for the combination of the first and a second media UIs from the data structure; and
simultaneously presenting the first and second media UIs using the retrieved presentation settings.

2. The media system of claim 1, wherein the multiple-media device is further configured for:
receiving a selection of the first media UI and a third media UI to be presented simultaneously;
retrieving presentation settings for the combination of the first and the third media UIs from the data structure; and
simultaneously presenting the first and third media UIs using the retrieved presentation setting, wherein the presentation settings for the combination of the first and third media UIs are different than the presentation settings for the combination of the first and second media UIs.

3. The media system of claim 1, wherein the multiple-media device is further configured for receiving user presentation settings for the combination of the first and second media UIs, receiving the user presentation settings comprising:
presenting the first and second media Ws using default presentation settings;
receiving, from a user, modifications of the presentation settings for the first and second media UIs; and
storing the modified presentation settings for the combination of the first and second media UIs to the data structure as an entry.

4. The media system of claim 1, wherein:
the plurality of media UIs present different types of media content comprising television content, Internet content, and personal content; and
each media UI specified in an entry of the data structure presents a different type of media content from another media UI in the same entry.

5. The media system of claim 1, wherein the presentation settings for the combination of the first and a second media Ills specifies video and audio settings for the first and second media UIs.

6. The media system of claim 5, wherein:
the video settings for the first media UI specify a position and size of a window for displaying the first media UI; and
the audio setting for the first media UI specifies an audio volume setting for presenting media content through the first media UI.

7. The media system of claim 1, further comprising:
a television coupled to the multiple-media device, the television comprising presentation components for presenting the media Ills, wherein the presentation components comprise video and audio components.

8. A computer readable medium having instructions stored thereon when executed by a processor, present multiple media user interfaces (UN), the computer readable medium comprising sets of instructions for:
storing a data structure comprising a plurality of entries, each entry specifying presentation settings, received from a user, for a combination of at least two media UIs being presented simultaneously;
providing a plurality of media UIs;
receiving a selection of a first media UI and a second media UI to be presented simultaneously;
retrieving presentation settings for the combination of the first and a second media UIs from the data structure; and
simultaneously presenting the first and second media UN using the retrieved presentation settings.

9. The computer readable medium of claim 8, further comprising sets of instructions for:
receiving a selection of the first media UI and a third media UI to be presented simultaneously;
retrieving presentation settings for the combination of the first and the third media UN from the data structure; and
simultaneously presenting the first and third media UIs using the retrieved presentation setting, wherein the presentation settings for the combination of the first and third media Ms are different than the presentation settings for the combination of the first and second media UIs.

10. The computer readable medium of claim 8, further comprising sets of instructions for receiving user presentation settings for the combination of the first and second media UIs, receiving the user presentation settings comprising:
presenting the first and second media UIs using default presentation settings;
receiving, from a user, modifications of the presentation settings for the first and second media UIs; and
storing the modified presentation settings for the combination of the first and second media UIs to the data structure as an entry.

11. The computer readable medium of claim 8, wherein:
the plurality of media UIs present different types of media content comprising television content, Internet content, and personal content; and
each media UI specified in an entry of the data structure presents a different type of media content from another media UI in the same entry.

12. The computer readable medium of claim 8, wherein the presentation settings for the combination of the first and a second media UIs specifies video and audio settings for the first and second media UIs.

13. The computer readable medium of claim 12, wherein:
the video settings for the first media UI specify a position and size of a window for displaying the first media UI; and
the audio setting for the first media UI specifies an audio volume setting for presenting media content through the first media UI.

14. The computer readable medium of claim 8, wherein:
the media UIs are presented on a television comprising presentation components for presenting the media UIs, wherein the presentation components comprise video and audio components.

15. A method for presenting multiple media user interfaces (UIs), the method comprising:
providing a memory device for:
storing a data structure comprising a plurality of entries, each entry specifying presentation settings, received from a user, for a combination of at least two media UIs being presented simultaneously;
providing a multiple-media device for:
providing a plurality of media UIs;
receiving a selection of a first media UI and a second media UI to be presented simultaneously;
retrieving presentation settings for the combination of the first and a second media UIs from the data structure; and
simultaneously presenting the first and second media Ills using the retrieved presentation settings.

16. The method of claim 15, further comprising:
receiving a selection of the first media UI and a third media UI to be presented simultaneously;
retrieving presentation settings for the combination of the first and the third media UIs from the data structure; and
simultaneously presenting the first and third media UIs using the retrieved presentation setting, wherein the presentation settings for the combination of the first and third media UIs are different than the presentation settings for the combination of the first and second media UIs.

17. The method of claim 15, further comprising receiving user presentation settings for the combination of the first and second media UIs, receiving the user presentation settings comprising:
presenting the first and second media UIs using default presentation settings;
receiving, from a user, modifications of the presentation settings for the first and second media UIs; and
storing the modified presentation settings for the combination of the first and second media UIs to the data structure as an entry.

18. The method of claim 15, wherein:
the plurality of media UIs present different types of media content comprising television content, Internet content, and personal content; and
each media UI specified in an entry of the data structure presents a different type of media content from another media UI in the same entry.

19. The method of claim 15, wherein the presentation settings for the combination of the first and a second media UIs specifies video and audio settings for the first and second media UIs.

20. The method of claim 19, wherein:
the video settings for the first media UI specify a position and size of a window for displaying the first media UI; and
the audio setting for the first media UI specifies an audio volume setting for presenting media content through the first media UI.

21. The method of claim 15, wherein:
the media UIs are presented on a television comprising presentation components for presenting the media UIs, wherein the presentation components comprise video and audio components.

22. A system for displaying a video channel or program on a monitor, the system comprising:
a media device configured for:
storing audio or video settings for one or more channels or programs;
receiving a selection of a channel or program from a user;
retrieving audio or video settings corresponding to the selected channel or program; and
displaying the selected channel or program according to the retrieved audio or video settings.

23. The system of claim 22, wherein the media device is further configured for:
receiving the audio or video settings for one or more channels or programs from a user.

24. The system of claim 22, wherein the media device is further configured for:
receiving a settings file through a network, the settings file comprising the audio or video settings for one or more channels or programs from a user.

25. The system of claim 22, wherein video settings comprise resolution, television standard, contrast, brightness, color saturation, hue, position, size, frame, field rate, sharpness, gamma curve, aspect ratio, or any combination thereof.
